(19) United States
(12) Patent Application Publication
(10) Pub. No.: US 2026/0238030 A1
(43) Pub. Date: Aug. 13, 2026

(54) DC Power Supply System with Fixed Output Voltage

(71) Applicant: AcePower and Technologies Co.,Ltd, Shanghai (CN)

(72) Inventors: Yuetian Wang, Shanghai (CN); Xingkuan Guo, Shanghai (CN)

(21) Appl. No.: 19/151,299

(22) PCT Filed: Aug. 10, 2023
(86) PCT No.: PCT/CN2023/112128

§ 371 Date: Jul. 25, 2025

(30) Foreign Application Priority Data
Jan. 9, 2023 (CN) 202310029459.3

(51) Int. Cl. H02J 7/00; H02J 7/34; H02J 7/62; H02J 7/68

(52) U.S. Cl. CPC H02J 7/855; H02J 7/34; H02J 7/62; H02J 7/68; H02J 2207/20

(57) ABSTRACT

The disclosure provides a DC power supply system with fixed output voltage, the system comprising at least one battery pack and a power module corresponding to each battery pack, wherein a first end of each battery pack is connected to the corresponding power module, a second end of each battery pack is connected to a DC bus, and an output of each power module is connected on the DC bus; wherein the first end of each battery pack is positive, and the second end of each battery pack is negative, or the first end of each battery pack is negative, and the second end of each battery pack is positive. The DC power supply system with fixed output voltage provided by the embodiment of the disclosure reduces the downstream DC distribution cost

### TECHNICAL FIELD

The disclosure relates to the technical field of a power supply device, and in particular to a DC power supply system with fixed output voltage.

### BACKGROUND

In the data room power supply, 24 hours of uninterrupted power supply is required. In order to improve the reliability of a power supply system, batteries are usually used as a back-up power source.

FIG. 1 is a structural schematic diagram of a DC power supply system. As shown in FIG. 1, the DC power supply system comprises a plurality of sets of power modules, a plurality of battery packs, and a plurality of sets of load shunts. The power module converts the input AC power into DC power output, and the plurality of battery packs are connected in parallel to the same DC bus. Since the voltage of the DC bus needs to match the voltage range of the battery pack, power distribution switches, cables, server power supplies and the like of downstream electric equipment need to meet the voltage range. Accordingly, the power distribution switches, the cables, the server power supplies and the like need to be selected in accordance with the lowest operating voltage, thus the switch capacity is large, the cable is thick, and the downstream DC distribution system has a high cost.

### SUMMARY

Aiming at the problems in the prior art, an embodiment of the present disclosure provides a DC power supply system with fixed output voltage, which can at least partially solve the problems existing in the prior art.

The disclosure provides a DC power supply system with fixed output voltage, comprising at least one battery pack and a power module corresponding to each battery pack, wherein,
a first end of each battery pack is connected to the corresponding power module, a second end of each battery pack is connected to a DC bus, and an output of each power module is connected on the DC bus, wherein the first end of each battery pack is positive, and the second end of each battery pack is negative, or the first end of each battery pack is negative, and the second end of each battery pack is positive.

Further, the first end of each battery pack is connected to the DC bus by a corresponding short circuit protection module.

Further, the short circuit protection module adopts a diode or a controllable silicon.

Further, the first and second ends of each battery pack are respectively provided with overcurrent protection modules.

Further, the overcurrent protection module adopts a fuse or a protection switch.

Further, each battery pack corresponds to a plurality of power modules.

Further, the power module comprises an input filter unit, an AC/DC conversion unit, an output filter unit, and a charging and discharging unit, wherein the input filter unit, the AC/DC conversion unit and the output filter unit are successively connected, the charging and discharging unit is connected to a line between the AC/DC conversion unit and the output filter unit, and the first end of the battery pack corresponding to the power module is connected to the charging and discharging unit.

Further, the power module further comprises an anti-backflow unit which is connected to an output end of the output filter unit.

Further, the power module further comprises a booster unit, and correspondingly, the charging and discharging unit is replaced with a charging unit, the booster unit is connected to the AC/DC conversion unit and the output filter unit respectively, and the charging unit is connected to a line between the AC/DC conversion unit and the booster unit.

Further, the booster unit comprises an inductor, a switching tube, a diode and a capacitor, wherein,
a first end of the inductor is connected to a first end of the AC/DC conversion unit, a second end of the inductor is connected to a positive pole of the diode and a first end of the switching tube respectively, a negative pole of the diode is connected to a first end of the capacitor, the negative pole of the diode is connected to a first end of the output filter unit, a second end of the switching tube is connected to a second end of the capacitor and a second end of the AC/DC conversion unit respectively, and a second end of the capacitor is connected to a second end of the output filter unit.

Further, the power module further comprises a voltage regulation unit which is connected to a line between the booster unit and the output filter unit.

The DC power supply system with fixed output voltage provided in the embodiment of the present disclosure comprises at least one battery pack and a power module corresponding to each battery pack, wherein the first end of each battery pack is connected to the corresponding power module, the second end of each battery pack is connected to the DC bus, and the output of each power module is connected on the DC bus, wherein the first end of each battery pack is positive, and the second end of each battery pack is negative, or the first end of each battery pack is negative, and the second end of each battery pack is positive. Since the battery pack is connected into the power module and is not directly connected in parallel to the DC bus, the voltage of the DC bus is not restricted by the voltage of the battery pack, and can be adjusted to a fixed value as required, and the power distribution switches, the cables and the like downstream the DC bus only need to meet the fixed voltage, thereby reducing the downstream DC distribution cost.

### BRIEF DESCRIPTION OF THE DRAWINGS

In order to more clearly explain the embodiments of the disclosure or the technical solution in the prior art, drawings that need to be used in the description in embodiments or the prior art will be simply introduced below, obviously the drawings in the following description are merely some examples of the disclosure, for persons ordinarily skilled in the art, it is also possible to obtain other drawings according to these drawings without making creative efforts.

FIG. 1 is a schematic diagram of a DC power supply system in the prior art provided by a first embodiment of the disclosure.

FIG. 2 is a schematic diagram of a DC power supply system with fixed output voltage provided by a second embodiment of the disclosure.

FIG. 3 is a schematic diagram of a DC power supply system with fixed output voltage provided by a third embodiment of the disclosure.

FIG. 4 is a schematic diagram of a DC power supply system with fixed output voltage provided by a fourth embodiment of the disclosure.

FIG. 5 is a schematic diagram of a DC power supply system with fixed output voltage provided by a fifth embodiment of the disclosure.

FIG. 6 is a schematic diagram of a DC power supply system with fixed output voltage provided by a sixth embodiment of the disclosure.

FIG. 7 is a schematic diagram of a DC power supply system with fixed output voltage provided by a seventh embodiment of the disclosure.

FIG. 8 is a schematic diagram of a DC power supply system with fixed output voltage provided by an eighth embodiment of the disclosure.

FIG. 9 is a schematic diagram of a power module provided by a ninth embodiment of the disclosure.

FIG. 10 is a schematic diagram of a power module provided by a tenth embodiment of the disclosure.

FIG. 11 is a schematic diagram of a power module provided by an eleventh embodiment of the disclosure.

FIG. 12 is a schematic diagram of a power module provided by a twelfth embodiment of the disclosure.

FIG. 13 is a schematic diagram of a power module provided by a thirteenth embodiment of the disclosure.

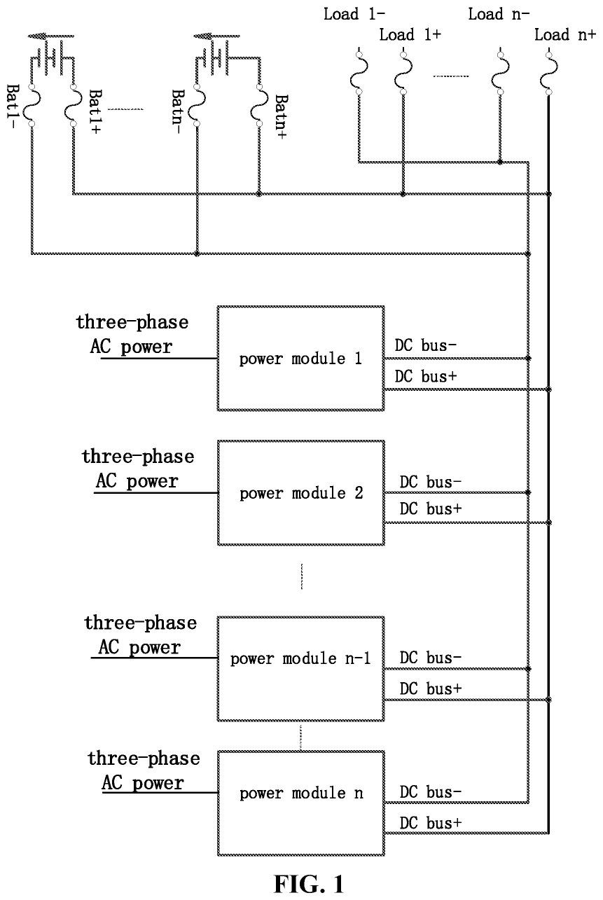

### DETAILED DESCRIPTION OF THE PREFERRED EMBODIMENTS

In order to more clearly explain purpose, technical solution and advantages according to embodiments of the disclosure, hereinafter the embodiments of the disclosure will be further described in detail in combination with the drawings. Here in the text, the schematic embodiments of the disclosure and the description thereof are used for explaining the disclosure and do not constitute definition to the disclosure. It should be noted that the embodiments in the present application and the features in the embodiments can be arbitrarily combined with each other without conflict.

In the DC power supply system with fixed output voltage provided in the embodiment of the present disclosure, each battery pack is connected to the corresponding power module, the charging and discharging process of each battery pack is controlled by the corresponding power module, so that the DC bus is not affected by the voltage of the battery pack, and the fixed voltage output can be maintained. Each battery pack is not connected in parallel to the same DC bus, so it is convenient to carry out charging and discharging test on a single battery pack separately, and there is no problem of overcharge and over-discharge of the battery pack, as well as flow equalization between the packs.

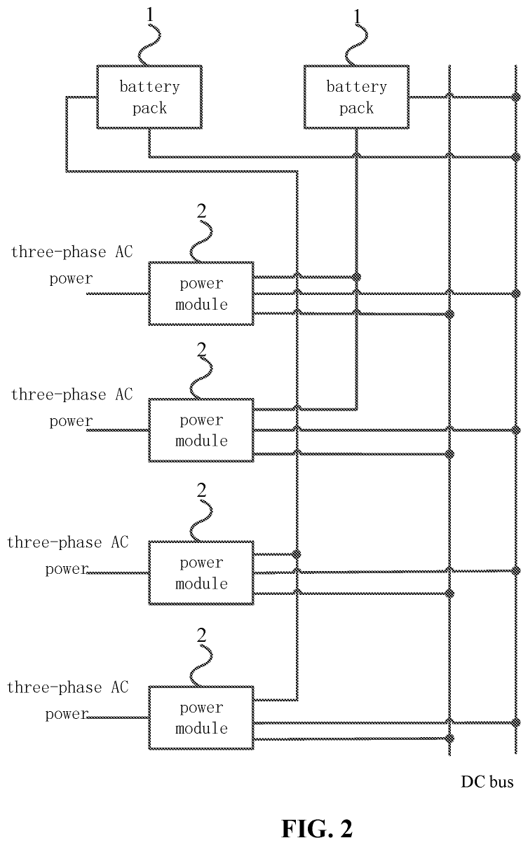

FIG. 2 is a schematic diagram of a DC power supply system with fixed output voltage provided by a second embodiment of the disclosure. As shown in FIG. 2, the DC power supply system with fixed output voltage provided in the embodiment of the present disclosure comprises at least one battery pack 1 and a power module 2 corresponding to each battery pack 1, wherein,
a first end of each battery pack 1 is connected to the corresponding power module 2, a second end of each battery pack 1 is connected to a DC bus, and an output of each power module 2 is connected on the DC bus; wherein the first end of each battery pack 1 is positive, and the second end of each battery pack 1 is negative, or the first end of each battery pack 1 is negative, and the second end of each battery pack 1 is positive.

Specifically, the input end of the power module 2 is connected to three-phase AC power, such as to the mains, the three-phase AC power is converted to DC power to be supplied to the DC bus, and the DC bus provides power to the load. The power module 2 charges the corresponding battery pack 1. When the three-phase AC power externally connected to the power module 2 is disconnected, the battery pack 1 replaces the corresponding power module 2 to provide DC power for the DC bus. When the first end of the battery pack 1 is positive, the second end of the battery pack 1 is negative, and the second end of the battery pack 1 is connected to the negative pole of the DC bus. When the first end of the battery pack 1 is negative, the second end of the battery pack 1 is positive, and the second end of the battery pack 1 is connected to the positive pole of the DC bus.

When the DC power supply system with fixed output voltage works normally, the power module 2 converts the external AC power to DC power to be supplied to the DC bus. When the external AC power stops due to abnormal conditions such as power failure, tripping or the like, the battery pack 1 supplies power to the DC bus to ensure that the load connected to the DC bus is powered on continuously.

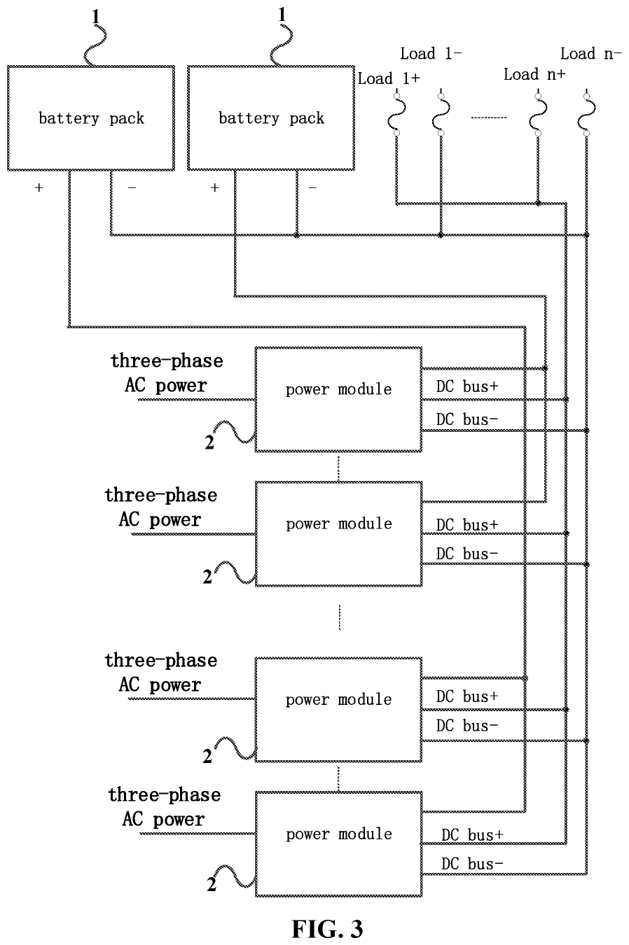

For example, as shown in FIG. 3, the first end of the battery pack 1 is positive, and the first end of the battery pack 1 is connected to the corresponding power module 2; the second end of the battery pack 1 is negative, and the second end of the battery pack 1 is connected to the negative pole of the DC bus. The number of the power module 2 corresponding to the battery pack 1 can be m, where m is a positive integer, and the specific value of m is set according to actual needs, such as 1, 2, 3, 4, 5, 6, 7, 8, 9, 10 and other positive integers, which is not limited in the embodiment of the disclosure. The DC bus can supply power to n loads, and the specific value of n is set according to the actual needs, which is not limited in the embodiment of the disclosure.

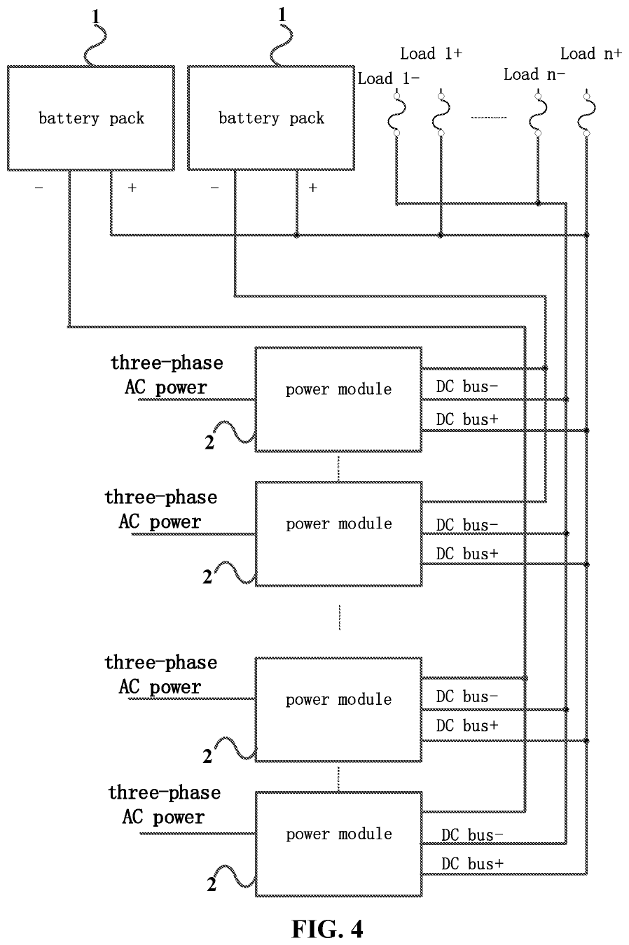

For example, as shown in FIG. 4, the first end of the battery pack 1 is negative, and the first end of the battery pack 1 is connected to the corresponding power module 2; the second end of the battery pack 1 is negative, and the second end of the battery pack 1 is connected to the positive pole of the DC bus. The number of the power module 2 corresponding to the battery pack 1 can be n, where n is a positive integer, and the number of the power modules 2 corresponding to the battery pack 1 is set based on the actual needs, such as 1, 2, 3, 4, 5, 6, 7, 8, 9, 10 and other positive integers, which is not limited in the embodiment of the disclosure The DC bus can supply power to n loads, and the specific value of n is set according to the actual needs, which is not limited in the embodiment of the disclosure.

The DC power supply system with fixed output voltage provided in the embodiment of the present disclosure comprises at least one battery pack and a power module corresponding to each battery pack, wherein the first end of each battery pack is connected to the corresponding power module, the second end of each battery pack is connected to the DC bus, and the output of each power module is connected on the DC bus, wherein the first end of each battery pack is positive, and the second end of each battery pack is negative, or the first end of each battery pack is negative, and the second end of each battery pack is positive. Since the battery pack is connected into the power module and is not directly connected in parallel to the DC bus, the voltage of the DC bus is not restricted by the voltage of the battery pack, and can be adjusted to a fixed value as required, and the power distribution switches, the cables and the like downstream the DC bus only need to meet the fixed voltage, thereby reducing the downstream DC distribution cost. In addition, the power module corresponding to each battery pack can perform independent charging and discharging management on the battery pack. The battery packs can also be used to regulate the power supply of the grid, i.e., peak cutting and valley filling for the grid power supply, thereby saving electricity.

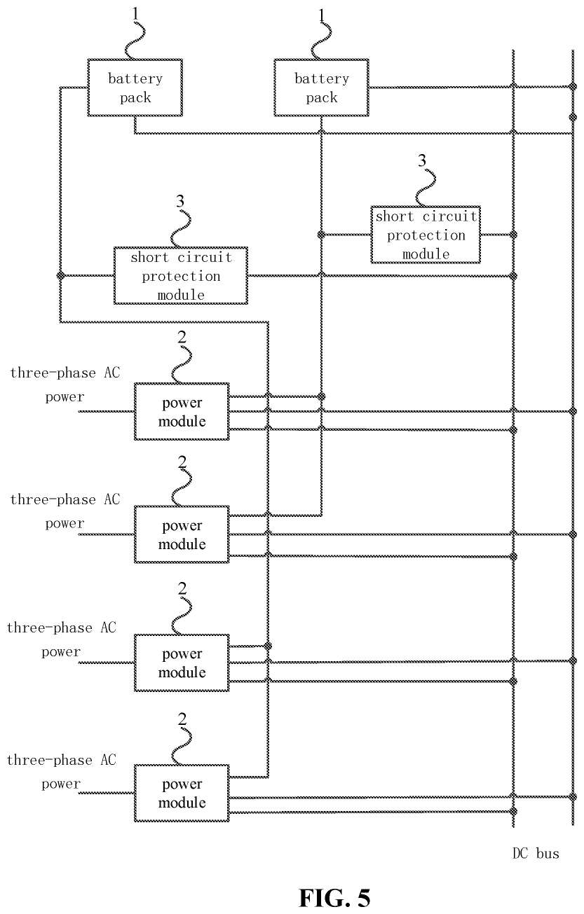

FIG. 5 is a schematic diagram of a DC power supply system with fixed output voltage provided by a fifth embodiment of the disclosure. As shown in FIG. 5, on the basis of the above embodiments, further, the first end of each battery pack 1 is connected to the DC bus by a corresponding short circuit protection module 3. The short circuit protection module 3 disposed between the battery pack 1 and the DC bus can improve the short-circuit current capability of the system, shorten the short-circuit protection operation time when the downstream load circuit is short, and quickly isolate the short-circuit fault. Wherein the short circuit protection module 3 can adopt a diode or a controllable silicon, which is selected according to actual needs, and is not limited in the embodiment of the disclosure.

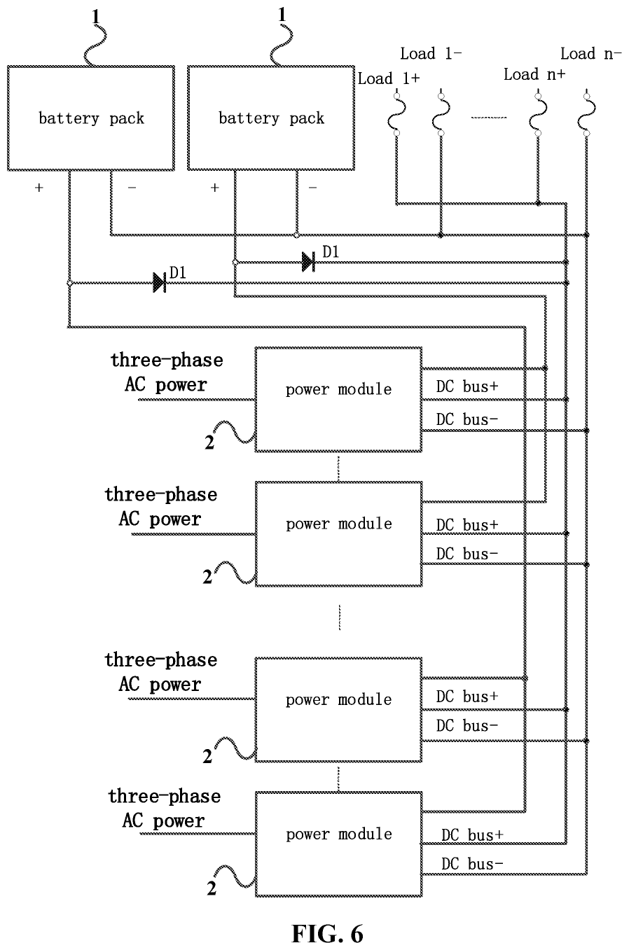

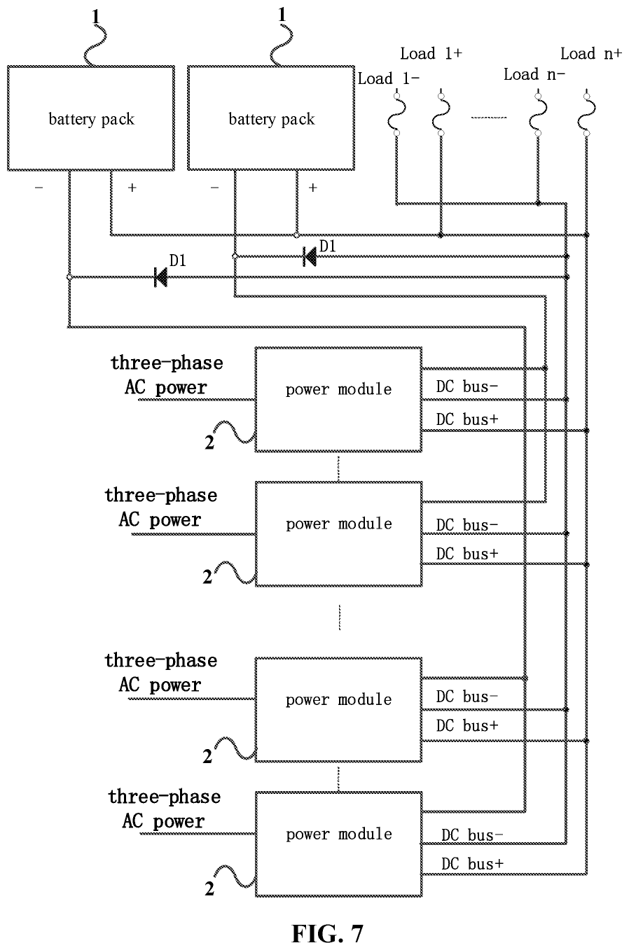

For example, the short circuit protection module 3 adopts a diode D1 As shown in FIG. 6, the first end of the battery pack 1 is positive, the first end of the battery pack 1 is connected to the positive pole of the corresponding first diode D1, and the negative pole of the first diode D1 is connected to the negative pole of the DC bus. As shown in FIG. 7, the first end of the battery pack 1 is negative, the first end of the battery pack 1 is connected to the negative pole of the corresponding first diode D1, and the positive pole of the first diode D1 is connected to the positive pole of the DC bus.

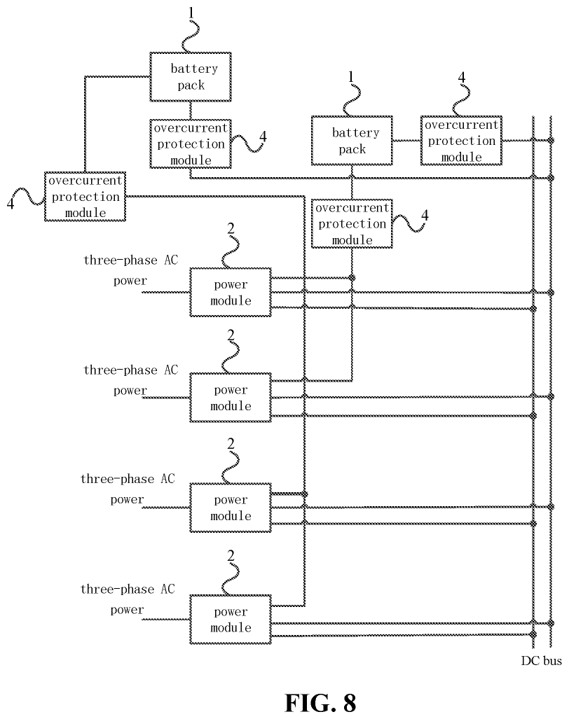

FIG. 8 is a schematic diagram of a DC power supply system with fixed output voltage provided by an eighth embodiment of the disclosure. As shown in FIG. 8, on the basis of the above embodiments, further, the first and second ends of each battery pack 1 are respectively provided with overcurrent protection modules 4. That is, an overcurrent protection module 4 is disposed between the first end of each battery pack and the corresponding power module 2, and an overcurrent protection module 4 is disposed between the first end of each battery pack and the corresponding DC bus. The short circuit current or overload current in the circuit is suppressed by the overcurrent protection module 4. The overcurrent protection module 4 can adopt a fuse or a protection switch, which is selected according to actual needs, and is not limited in the embodiment of the disclosure.

On the basis of the above embodiments, further, each battery pack 1 corresponds to one or more power modules 2. The specific number of the power module 2 corresponding to each battery pack 1 is set according to actual needs, which is not limited in the embodiment of the disclosure.

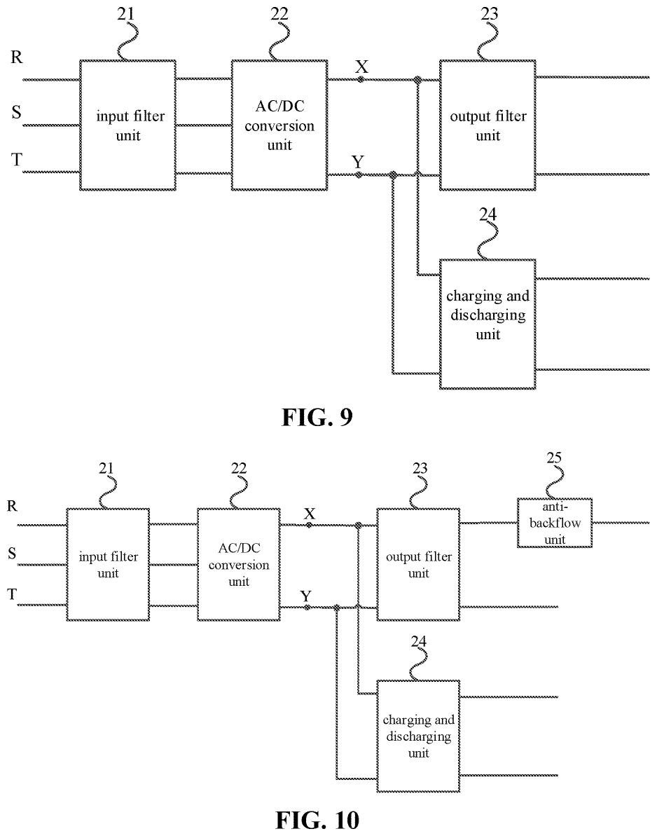

FIG. 9 is a schematic diagram of a power module provided by a ninth embodiment of the disclosure. As shown in FIG. 9, on the basis of the above embodiments, further, the power module 2 comprises an input filter unit 21, an AC/DC conversion unit 22, an output filter unit 23, and a charging and discharging unit 24, wherein the input filter unit 21, the AC/DC conversion unit 22 and the output filter unit 23 are successively connected, the charging and discharging unit 24 is connected to a line between the AC/DC conversion unit 22 and the output filter unit 23, and the first end of the battery pack 1 corresponding to the power module 2 is connected to the charging and discharging unit 24.

Specifically, the input end of the input filter unit 21 is connected to three-phase AC power, which is used to filter out electromagnetic interference in the AC power. The AC/DC conversion unit 22 is used to convert the input AC power to the DC power to be output. The output filter unit 23 is used to eliminate electromagnetic interference in the input DC power. A positive output end of the output filter unit 23 is connected to the positive pole of the DC bus, and a negative output end of the output filter unit 23 is connected to the negative pole of the DC bus. When the power module 2 charges the battery pack 1, the charging and discharging unit 24 converts the input DC power into the current that charges the battery pack 1. When the battery pack 1 supplies power to the DC bus, the charging and discharging unit 24 converts and outputs the DC power from the battery pack 1.

When the first end of the battery pack 1 corresponding to the power module 2 is positive, a positive output end X of the AC/DC conversion unit 22 is connected to the first end of the battery pack 1 by the charging and discharging unit 24, a negative output end Y of the AC/DC conversion unit 22 is connected to the second end of the battery pack 1 by the charging and discharging unit 24 and the negative pole of the DC bus, and the second end of the battery pack 1 is connected to the negative pole of the DC bus. When the first end of the battery pack 1 corresponding to the power module 2 is negative, a negative output end Y of the AC/DC conversion unit 22 is connected to the first end of the battery pack 1 by the charging and discharging unit 24, a negative output end Y of the AC/DC conversion unit 22 is connected to the second end of the battery pack 1 by the charging and discharging unit 24 and the negative pole of the DC bus, and the second end of the battery pack 1 is connected to the positive pole of the DC bus.

FIG. 10 is a schematic diagram of a power module provided by a tenth embodiment of the disclosure. As shown in FIG. 10, on the basis of the above embodiments, further, the power module 2 further comprises an anti-backflow unit 25 which is connected to an output end of the output filter unit 23.

Specifically, the anti-backflow unit 25 is used to prevent the current of the output end of the output filter unit 23 from pouring back into the power module 2 to improve the safety of the power module. The anti-backflow unit 25 can adopt a diode, the positive pole of the diode is connected to the positive output end of the output filter unit 23, and the negative pole of the diode is connected to the positive pole of the DC bus.

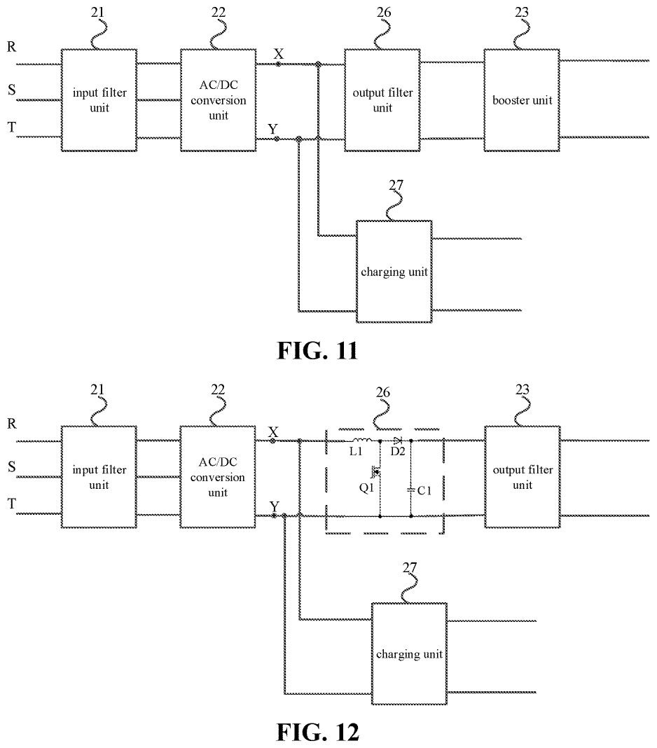

FIG. 11 is a schematic diagram of a power module provided by an eleventh embodiment of the disclosure As shown in FIG. 11, on the basis of the above embodiments, further, the power module 2 comprises an input filter unit 21, an AC/DC conversion unit 22, an output filter unit 23, a charging unit 27and a booster unit 26, wherein the input filter unit 21, the AC/DC conversion unit 22, the booster unit 26 and the output filter unit 23 are successively connected, the booster unit 26 is connected to the AC/DC conversion unit 22 and the output filter unit 23 respectively, the charging unit 27 is connected to the line between the AC/DC conversion unit 22 and the booster unit 26, and the first end of the battery pack 1 corresponding to the power module 2 is connected to the charging unit 27.

Specifically, the booster unit 26 is used to convert the input voltage of the booster unit 26 to a target voltage to be output, and can act as a discharging unit when the battery pack 1 is discharged. When the external three-phase AC power supply is used, the booster unit 26 converts the voltage output from the AC/DC conversion unit 22 into the target voltage to be output. When power is supplied by the battery pack 1, the booster unit 26 converts the voltage output from the battery pack 1 into the target voltage to be output. When the first end of the battery pack 1 corresponding to the power module 2 is positive, the positive output end X of the AC/DC conversion unit 22 is connected to the first end of the battery pack 1 by the charging unit 27, the negative output end Y of the AC/DC conversion unit 22 is connected to the second end of the battery pack 1 by the charging unit 27 and the negative pole of the DC bus, and the second end of the battery pack 1 is connected to the negative pole of the DC bus. When the first end of the battery pack 1 corresponding to the power module 2 is negative, the negative output end Y of the AC/DC conversion unit 22 is connected to the first end of the battery pack 1 by the charging unit 27, the negative output end Y of the AC/DC conversion unit 22 is connected to the second end of the battery pack 1 by the charging unit 27 and the negative pole of the DC bus, and the second end of the battery pack 1 is connected to the positive pole of the DC bus.

FIG. 12 is a schematic diagram of a power module provided by a twelfth embodiment of the disclosure. As shown in FIG. 12, on the basis of the above embodiments, further, the booster unit 26 comprises an inductor L1, a switching tube Q1, a diode D2 and a capacitor C1, wherein,
A first end of the inductor L1 is connected to a first end of the AC/DC conversion unit 22, a second end of the inductor L1 is connected to a positive pole of the diode D2 and a first end of the switching tube Q1 respectively, a negative pole of the diode D2 is connected to a first end of the capacitor C1, the negative pole of the diode D2 is connected to a first end of the output filter unit 23, a second end of the switching tube Q1 is connected to a second end of the capacitor C1 and a second end of the AC/DC conversion unit 22 respectively, and a second end of the capacitor C1 is connected to a second end of the output filter unit 23.

Specifically, when the switching tube Q1 is turned on, the current in the inductor L1 rises. When the power switching tube Q1 is turned off, the current stored in the inductor L1 charges the capacitor C1 through the diode D2. When the voltage across both ends of the capacitor C1 reaches the target voltage, the output filter unit 23 is made to output the target voltage. The specific models and parameters of the inductor L1, the switching tube Q1, the diode D2 and the capacitor C1 are selected according to the actual needs, which is not limited in the embodiment of the disclosure.

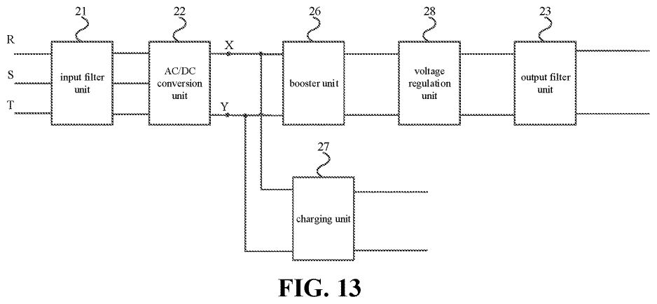

FIG. 13 is a schematic diagram of a power module provided by a thirteenth embodiment of the disclosure. As shown in FIG. 13, on the basis of the above embodiments, further, the power module 2 further comprises a voltage regulation unit 28 which is connected to a line between the booster unit 26 and the output filter unit 23. In order to prevent the booster unit 26 from raising the voltage too high, the voltage regulation unit 28 is set to adjust the voltage boosted by the booster unit 26 to the target voltage.

In the description, reference terms “one embodiment”, “one specific embodiment”, “some embodiments”, “for example”, “example”, “specific example” or “some examples” are used to mean that specific features, structures, materials or characteristics described by combining the embodiment or example are included in at least one embodiment or example of the disclosure. In the description, exemplary expression of the above terms does not necessarily refer to the same embodiment or example. Moreover, the described specific features, structures, materials or characteristics may be combined in a suitable manner in any one or more of the embodiments or examples.

The purpose, technical solution and beneficial effect of the disclosure have been further described in detail in the above specific embodiments, it should be understood that the above contents are merely specific embodiments of the disclosure and are not for limiting protection scope of the disclosure, and any modifications, equivalent replacements, improvements and the like within the spirit and principle of the present disclosure shall be included within the protection scope of the present disclosure.

1. A DC power supply system with fixed output voltage, wherein comprising at least one battery pack and a power module corresponding to each battery pack, wherein,
a first end of each battery pack is connected to the corresponding power module, a second end of each battery pack is connected to a DC bus, and an output of each power module is connected on the DC bus; wherein the first end of each battery pack is positive, and the second end of each battery pack is negative; or the first end of each battery pack is negative, and the second end of each battery pack is positive.

2. The DC power supply system with fixed output voltage according to claim 1, wherein the first end of each battery pack is connected to the DC bus by a corresponding short circuit protection module.

3. The DC power supply system with fixed output voltage according to claim 2, wherein the short circuit protection module adopts a diode or a controllable silicon.

4. The DC power supply system with fixed output voltage according to claim 1, wherein the first and second ends of each battery pack are respectively provided with overcurrent protection modules.

5. The DC power supply system with fixed output voltage according to claim 4, wherein the overcurrent protection module adopts a fuse or a protection switch.

6. The DC power supply system with fixed output voltage according to claim 1, wherein each battery pack corresponds to a plurality of power modules.

7. The DC power supply system with fixed output voltage according to claim 1, wherein the power module comprises an input filter unit, an AC/DC conversion unit, an output filter unit, and a charging and discharging unit, wherein the input filter unit, the AC/DC conversion unit and the output filter unit are successively connected, the charging and discharging unit is connected to a line between the AC/DC conversion unit and the output filter unit, and the first end of the battery pack corresponding to the power module is connected to the charging and discharging unit.

8. The DC power supply system with fixed output voltage according to claim 7, wherein the power module further comprises an anti-backflow unit which is connected to an output end of the output filter unit.

9. The DC power supply system with fixed output voltage according to claim 7, wherein the power module further comprises a booster unit, and correspondingly, the charging and discharging unit is replaced with a charging unit; the booster unit is connected to the AC/DC conversion unit and the output filter unit respectively, and the charging unit is connected to a line between the AC/DC conversion unit and the booster unit.

10. The DC power supply system with fixed output voltage according to claim 9, wherein the booster unit comprises an inductor, a switching tube, a diode and a capacitor, wherein,
a first end of the inductor is connected to a first end of the AC/DC conversion unit, a second end of the inductor is connected to a positive pole of the diode and a first end of the switching tube respectively, a negative pole of the diode is connected to a first end of the capacitor, the negative pole of the diode is connected to a first end of the output filter unit, a second end of the switching tube is connected to a second end of the capacitor and a second end of the AC/DC conversion unit respectively, and a second end of the capacitor is connected to a second end of the output filter unit.

11. The DC power supply system with fixed output voltage according to claim 9, wherein further comprising a voltage regulation unit which is connected to a line between the booster unit and the output filter unit.
